(19) United States
(12) Patent Application Publication
(10) Pub. No.: US 2010/0205023 A1
(43) Pub. Date: Aug. 12, 2010

(54) SYSTEM AND METHOD FOR DISTRIBUTING DIGITAL CONTENT

(75) Inventor: Byron Wagner, Sherman Oaks, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: DIGIBOO LLC, Encino, CA (US)

(21) Appl. No.: 12/576,125

(22) Filed: Oct. 8, 2009

Related U.S. Application Data
(60) Provisional application No. 61/103,853, filed on Oct. 8, 2008.

(51) Int. Cl. G06F 15/16; G06F 12/08; G06F 13/38; G06F 3/048; G06F 17/30; G06Q 10/00; G06Q 40/00; G06Q 30/00

(52) U.S. Cl. 705/7; 711/103; 710/65; 715/764; 709/203; 711/E12.002; 707/769; 707/E17.014

(57) ABSTRACT

A system and method for high speed and convenient delivery of digital content to a user is described. The system and method include systems for providing digital content to a user, monitoring and controlling an interface between the user and the system to provide for purchase or lease of digital content by the user. The system also includes a novel portable digital content storage device for receiving downloaded digital content for later use by the user on the user's playback equipment. The system and method also provide for control of the digital content in accordance with digital rights management and other content usage conditions. Also provided is an adaptor connectable to the portable storage device to convert signals representative of the digital content stored in the portable storage device to a form usable by a user's playback or storage equipment.

### FIELD OF THE INVENTION

The present invention is directed to systems and methods for communicating and distributing large amounts of digital data, particularly data in audio, video or high definition audio or video formats, ebooks, emagazines, data for use in conjunction with computer or video games works of art, and other applications involving the downloading of large amounts of data or information to retail customers. More specifically, the present invention includes systems and methods for rapidly and accurately distributing and downloading such digital data upon purchase at a purchase point, which may be either dedicated, such as a kiosk located at a mall, or through a wired or wireless connection to a distribution system, which may be located at fixed location such as a residence, or portable, such as a laptop, cell phone or the like, such that the digital data is downloaded onto a personal data memory within a convenient amount of time approaching that which allows a customer to purchase the digital data and receive the download without an inconvenient wait.

### BACKGROUND

Historically, the content of entertainment media has been distributed using electronic transmission systems, such as telegraph, radio, or television. The content of these transmissions are ephemeral, and are primarily intended for synchronous contemporaneous consumption by a consumer. More recently, such content has been embodied and distributed in a physical form, such as paper, vinyl, film, magnetic tape or polycarbonate discs. For example, music has been distributed using various forms of vinyl records, compact discs, magnetic tapes and DVDs. Television and movies have been distributed using various magnetic tape and DVD formats. By definition, these physical media needed to be inexpensive, safe, reasonably durable, capable of sustaining multiple uses, and to occupy the smallest physical volume possible for the purposes of shipping and storage.

The idea of using a physical medium that was reusable for the purpose of temporarily containing the media content for the “last mile” between the retail distribution point and consumer premises has previously not been economically viable. Such prior physical media provided no advantages of scale, no cost-effective storage at the customer's location or other factors that would make such a scheme viable. Instead, media transmission and storage systems developed around technologies that were incremental improvements on existing publishing models, such as books, piano rolls, and still photographs.

In each of the prior art media, the method and speed of replication, such as by printing press, record stampers and compact disc presses, drove the economy of scale which allowed the physical medium or container to become no more than a minor contribution to the final cost of goods, the price the customer was required to pay to enjoy the works performed, and to the cost of re-experiencing them “on demand” over a reasonably lengthy period of time.

Another approach to providing media content by providing reusable (that is, erasable) media containers such as erasable compact discs, DVDs or tape that would be filled with content on demand of a consumer has also proven unwieldy. The labor-intensive quality control required to reliably reuse erasable material was never justifiable. Providing such content is very unlike other analogous situations such as in the milk or soda delivery business, where the content is an easily standardized commodity and container cost is significant compared to the intrinsic value of the contents.

More recent media distribution systems have attempted to leverage the installed base of capital-intensive infrastructure. For example, home taping of audio content was an esoteric hobby practiced only by audiophiles with expensive open reel tape recorders until the Norelco/Philips compact cassette became inexpensive, ubiquitous, and evolved in stability and fidelity to the point it that it became physically and economically practical to record music in pre-packaged format and distribute it to consumers.

Once inexpensive recording equipment and tape cassettes became available, consumer playback equipment, such as combination radio-cassette decks, made it practical to create mixed tapes for oneself and friends and to extend that customized listing experience to the home and the inside of a car moving down a highway. It is notable that until such radio-cassette players were available for the car, the only vehicle that was equipped by the manufacturer to provide entertainment other than spoken news and music through a car's radio was the Edsel by Ford Motor Company, which was available with an optional 45 rpm record changer shock mounted in the trunk.

Similarly, machines capable of recording television broadcasts soon assumed a cassette cartridge form and were mass marketed (originally ostensibly for time shifting purposes) and brought that capability into the average household. The resulting unanticipated re-purposing of the machines as a non-broadcast alternative distribution channel almost completely ignored the reusable capability of the physical media involved.

In each of the above mentioned examples, the common denominator that dictated a medium's success in the marketplace was the convenience, ease of use, and simplicity of operation that allowed a customer with no technical skills to enjoy the benefits of what had previously been a complex, sophisticated, and technically demanding mechanical challenge.

The advent of the Internet opened a new channel for distribution of media content. However, in its early days, most consumers were only able to connect to the Internet at relatively slow connection speeds. For example, even when dial-up connections to the Internet sported speeds of 56 kilobits per second, a significant improvement over early connection speeds, the only media that lent themselves to distribution electronically were text documents, low-resolution still images, and symbolic representations of real-time performances, including musical notation, midi files, and maps.

Recent improvements in technology provided inexpensive high speed broadband Internet connections to consumers and the development of internationally accepted standards for sub-band coding and compression of audio, such as, for example, Musicam and MP3, continuous tone still images, such as Group 3 fax and JPEG, and video, such as QuickTime, Real video, Windows media player, and the various MPEG formats, forever changed the economics of mass media distribution. The industry and technology continue to raise the bar, with high definition television, digital audio, portable media players, media playback capabilities on cell phones and laptop computers now being widely available at affordable prices. However, this new technology comes with a price, that is, the newer content requires vastly more bandwidth for transmission to consumers.

At present, a chasm has developed in the supply and demand systems that satisfy consumer needs for media distribution. People's expectations in terms of the availability of media on demand have been raised by their experience online using mechanisms like YouTube, iTunes and various search engines. However, only the highest speed optical fiber based broadband Internet access can reliably provide the same resolution of video and audio currently delivered by traditional disposable physical media, including CD's, DVDs, and Blu-Ray™ high definition DVDs. Although these physical formats are small enough to be transported from location to location, and even be enjoyed in a moving vehicle, the storage density, navigational speed, and lack of indexing by content leave much to be desired.

This problem of providing entertainment content has also been addressed previously by traditional brick and mortar institutions, such as Blockbuster. This approach, while successful for a time, is also experiencing problems as consumers become more conditioned to ease of selection available from on-line sources of content. For example, to rent or buy a DVD for viewing, a consumer typically goes to a specialized store having a large selection of DVDs to choose from. The consumer must then physically browse through the various titles until he or she finds one or more of interest, then stand in line to rent the material. The DVD must be returned to the store after a period of time to prevent incurrence of additional fees.

As early as the 1980s, systems were proposed to accommodate this problem and simultaneously increase the available breadth and depth of back catalog titles and new releases available to be distributed to a consumer using some form of “manufacture on demand” distribution in a user-friendly and convenient “kiosk” form factor. Such kiosks were designed to be initially located within traditional content resellers, such as, for example, record stores and videotape rental businesses, but the kiosk systems all suffered from a common problem, specifically, the replication speed required to produce a recording that could be carried away by a buyer was simply to slow to allow for timely and convenient purchase and delivery of the product. The time required to copy a selection, such as a music or film performance from an encrypted master disk, such as the customized twelve inch laserdisc jukebox system manufactured by Personics, or a customized cassette or CD was four to twelve minutes, a period of time that exceeded most buyers' patience, no matter how motivated the buyer was.

As broadband technology has progressed, consumers have come to expect shorter and shorter content delivery times as broadband connections have become increasingly faster. The rapid download speeds available for most content, such as textural and static graphical content, typically present on the World Wide Web, however, have conditioned consumers to expect downloads in real time, that is, the material is delivered to the consumer within seconds of its having been ordered by a mouse click or key stroke.

Customers are no longer satisfied with grainy, postage stamp sized video playback on their computers, televisions and other playback devices. High definition digital images have taken hold of the marketplace, now that high definition video and film content is widely available via over-the air-broadcast, satellite and optical media.

However, even the most rapid download speeds currently available cannot deliver television programs and films in small fractions of real time, instead, the time required to download programs of episodic television shows or feature films at even standard definition, much less high-definition or theatrical resolution, over current broadband connectivity is often measured in hours, which can be many multiples of the material's actual playing time. For this reason, consumer acceptance of on-line delivery or streaming of such content has been limited to relatively short length video recordings, such as those found on You Tube. Consumers do, however, seem willing to accept services, such as Netflix, which allows movies to be ordered on line and then delivered by mail. Such services however, require planning and do not provide the consumer with a spontaneous real-time satisfactory experience.

The high speeds currently available through the Internet, however, while capable of providing film and video content, still are not fast enough to provide the kind of broadband, high definition playback that is available to consumers through other means. Times have changed, and today's consumers want convenience, quality, breadth of choice, price, compatibility, and portability. Even with the most advanced Internet speeds available, it typically takes hours to completely download a high quality movie from a server.

What has been needed, and heretofore unavailable, is a system where a buyer can rapidly and conveniently search through a database of content to select content to purchase or lease that is then delivered to the consumer in a short, convenient time period of at most minutes, instead of hours. Such a system would include aspects designed to protect content owner's digital rights, and allow for playback on a variety of platforms. Additionally, depending on the whether the content is rented or purchased, the system could include a feature that would allow the consumer to easily add to the rental period or which would block the content from being played after the rental period has expired. The present invention addresses these, and other needs.

### SUMMARY OF THE INVENTION

In its broadest aspect, the present invention includes a system and method for distributing digital content to a consumer at a transfer rate that provides for delivery of the content to the consumer in a short period of time, on the order of minutes, rather than the hours it presently takes to download data files of the size associated with high definition movies and television programs. In other aspects, the system and methods of the present invention include back office functions, such as inventory management, billing, monitoring and tracking. One particular aspect includes a secure flashcard that is capable of rapid acceptance of content and that can interface with a user's playback equipment. Such a secure flashcard may include both ExpressCard and USB technology. In still another aspect, the system and method includes an adapter for accepting the secure flash card and then converting the data from secure flash card into a format or signal stream that can be used by wide variety of consumer playback devices.

In still another aspect, the invention includes a method for providing digital content to a user, comprising: providing digital content in a searchable database located on a server in communication with a user-accessible point of delivery; providing software programs for configuring the operation of a processor and associate memory to facilitate provision of user-selected digital content to the user, including programs for allowing a user to search the searchable database of digital content, programs for controlling the retrieval of digital content from the searchable database, programs for managing the searching and selecting process, programs for tracking the searching, selecting and delivery processes, programs for monitoring inventory, including stocking and re-stocking, programs for providing accounting functions associated with the delivery of the selected digital content, including functions associated with buying and/or leasing the selected digital content, including operations related to communicating with and charging or debiting a user's bank account, programs for providing digital rights management of the provided digital content, and programs for providing reporting of inventory usage, revenue generation and expenses and any other reports necessary to track usage, and in the case of a lease of the digital content, track the term of the lease, charge additional amounts to a user's account if the digital content is not returned at the end of the lease, or to incorporate within the download of digital content to a user supplementary content that would result in the deletion of the downloaded digital content at the end of the term of a lease; wherein the user-accessible delivery point includes facilities for local storage of digital content, interface means for allowing the user to interface with the system for searching for and selecting digital content to be delivered, and for providing a means for the user to purchase or lease the digital content, including means for charging the user's credit or debit account for an amount associated with the lease or purchase of the digital content; and a communication port configured to allow for rapid downloading of digital content to a portable memory device for use by the use with user accessible digital content playback devices.

In yet another aspect, the invention includes a portable memory storage device, comprising: a high speed data port, such as a PCIE port; a USB port; electronic circuitry, including conversion means in operable communication with the PCIE port to convert data flow from the PCIE port to a form usable by a flash memory; a USB hub, controller and associated memory in operable communication with the USB port, an output port, communication means providing for data flow between the PCIE input port, USB input port, the conversion means, flash memory, and a USB hub and controller and the output port; wherein the controller controls the flow of data through the electronic circuitry. In another aspect, the PCIE port is configured to receive digital content from a digital content delivery system. In still another aspect, the received digital content is stored in the flash memory of the portable memory storage device.

In yet another aspect, the stored output port of the portable memory storage device is releasably connected to a playback or storage device, and the controller provides for retrieval of digital content stored in the flash memory which is then communicated under user control through the output port to the playback or storage device.

In still another aspect the controller of the portable memory storage device is programmed to provide a capability for communicating digital content stored in the flash memory to the output in accordance with digital rights management conditions or provider usage conditions stored in the memory or flash memory.

In a further aspect, the invention includes a customer point of content delivery system for providing digital content to a customer, comprising: a user-interface, including input and output capabilities, an escrow controller; an output configured to interface with and communicate with a portable digital content storage device; a processor configured to operate in accordance with software to control the display of content on the user interface and to accept user input, the processor responsive to the user input to control the display of information to the user and to control the escrow controller to provide for downloading user selected digital content through the output. In another aspect, the controller is in communication with a server, the server being part of a digital content supply system for supplying digital content to the delivery system for delivery to the user through the output, the server also being part of management control system for managing, monitoring and controlling the delivery of digital content to the user and for managing, monitoring and controlling purchase or lease processes associated with delivery of the digital content to the user.

In still another aspect, the invention includes an adaptor for receiving digital content from a portable content storage device and converting the signals representing the digital content to a form usable by a playback or display device, comprising: a connector for operably communicating with a portable content storage device; conversion means for converting digital content to a form usable by a playback or display device; memory for storing programming used to control conversion means and for controlling the flow of date through the adaptor; input means for accepting user input; output means for operably communicating output of the conversion means to a playback or display device in operable communication with the output means; and a processor for controlling the conversion means and the flow of digital content through the adaptor in accordance with user input and also in accordance with programming stored in the memory. In a further aspect, the conversion means includes means for converting data, video information and audio information. In a still further aspect, the invention further comprising a status indicator for indicating the status of operation of the adaptor to a user.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIGS. 1A and 1B are block diagrams representing one embodiment of the overall architecture and data flow of the present invention, graphically showing various servers, networks and distribution kiosks for delivery digital content from content providers to end-consumers.

FIG. 2 is a block diagram illustrating one embodiment of the architecture of a distribution kiosk of FIG. 1A.

FIG. 3 is a block diagram of one embodiment of a secure flashcard in accordance with the present invention showing various components, data flow and connections.

FIG. 4 is block diagram of one embodiment of an adaptor that can be used to interface a secure flash card in accordance with various embodiments of the present invention with various audio and video display and playback devices.

### DETAILED DESCRIPTION OF THE PREFERRED EMBODIMENTS

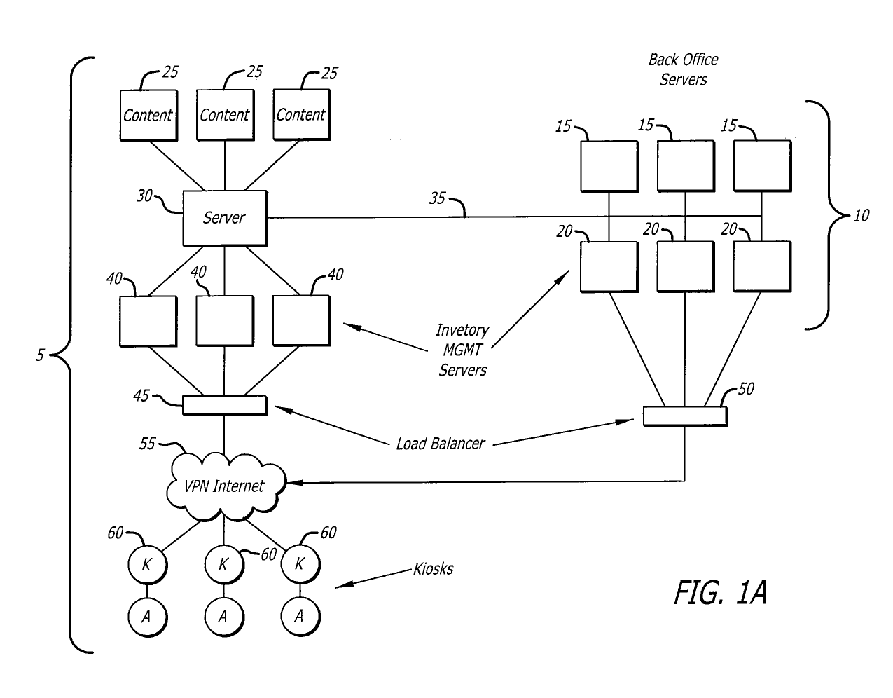

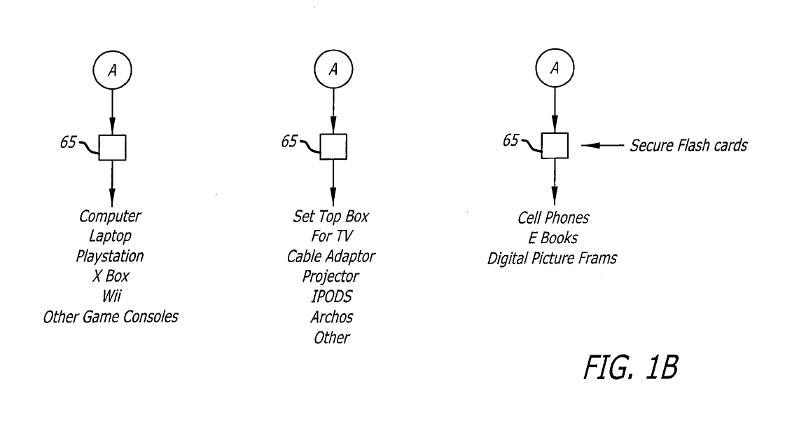

Referring now to the drawings in detail, in which like reference numerals indicate like or corresponding elements among the several figures, there is shown in FIG. 1 one embodiment of a distribution system for providing digital content to a consumer in a convenient manner that reduces customer waiting time while the content is downloaded to a portable format while still providing breadth of choice and low price.

As shown in FIG. 1, the distribution system typically includes a content delivery portion 5 and a back office management portion 10. Back office management portion will include one or more servers, databases, data storage, printers, input devices and other equipment 15 that are interconnected using appropriate high speed connections, such as are provided by Ethernet or other networking and communication systems that are well known in the art. Additionally, back office management portion 10 also includes servers and databases 20 that provide for inventory management and tracking of digital content sales or rentals. Those skilled in the art will understand that while the back office management portion 10 is described as having servers and databases that are separate from the inventory management servers, such servers may be included in the same machine or database, depending on the software and hardware being used.

Referring now to content delivery portion 5, FIGS. 1A and 1B illustrate that content delivery portion 5 includes a server 30 that has access to various content databases 25. Communication with content databases 25 may be accomplished through dedicated communication lines, or alternatively, high-speed Internet or Ethernet communication systems, which may be either wired or wireless. Server 30 of content delivery portion 5 is also in communication with management portion 10 through communication link 35. As before, communication link 35 may take several forms. For example, communication link 35 may be either hardwired or wireless, and provide communication to management portion 10 or other parts or sub-parts of the system in accordance with the present invention. Alternatively, content delivery portion 5 may communicate with management portion 10 through wired or wireless Ethernet or Internet connections. In this manner, the servers 15 of management portion 10 may be updated with information from content delivery portion 5 with information appropriate to the delivery of the content in the ongoing running of the business. For example, data communicated over communication line 35 may include not only ordering and leasing information, but also may include, without limitation, delivery information, inventory information, availability of various content information and other information required to provide for the content delivery and subsequent billing and other back office operations in a cost effective and efficient manner.

Along this line, inventory management servers 40 are also connected to server 30 of content delivery portion 5. These inventory management servers may be similar or identical to inventory management servers 20 that form a portion of the management portion 10 of the system. Those skilled in the art understand that while content delivery portion 5 or management servers 40 have been depicted separately from the inventory management servers 20 of management portion 10, these servers could indeed, be located either in actual or virtual fashion on the same server. Such an integrated server may also be physically located, or virtually located, in either the content delivery portion 5 or the management portion 10 of the system of one embodiment of the present invention. It will also be understood that the various component portions of various embodiments of the present invention may also be included as part of an integrated system, where back office servers 15, inventory management servers 20 and 40 and content delivery portion server 30 all reside on the same machine or network of machines through appropriate software, the functions of the various servers being provided from a single location.

Referring again to FIG. 1, inventory management servers 40 of content delivery portion 5 are in communication with other portions of the system through load balancer 45. Such load balancers are well known by those skilled in the art, and thus do not need to be described in detail herein.

Similarly to load balancer 45, load balancer 50 provides for a gateway to the servers of the management portion 10. Both the management portion 10 and the content delivery portion 5 are in communication with various content delivery stations that are accessible by computers through the Internet 55. As those skilled in the art will understand, to provide for a secure connection between the various servers of the content delivery portion 5 and the management portion 10, Internet connectively may be provided through a virtual private network (VPN).

In one embodiment of the preferred invention, customers interface with the content delivery portion 5 of the system using a kiosk or kiosks 60 that are positioned in a consumer accessible location. For example, kiosks may be located in malls, grocery stores, gas stations, and the like, or in any other publicly available space warranted by consumer traffic.

As will be described in more detail below, a customer interfaces with the content delivery system 5 at kiosk 60 through the use of secure flash card 65. Devices have flash memory are well known and in common use as portable storage media. For example, devices known as “thumb drives” utilize flash memory. Flash memory cards are available in several different footprints, and various interface or connection standards are used to store and retrieve information in their flash memory. Such cards also include additional ancillary processors and circuitry to control the flow of date into and out of the flash memory of the card.

Kiosks 60 include data ports that are configured to accept the secure flash cards 65 to enable digital content to be downloaded into the secure flash card 65 at the kiosk. Additional details of the components of various embodiments of kiosks 60 will be described in more detail below.

Once the customer has completed their transactions at the kiosk and digital content has been downloaded into the secure flash card 65, the secure flash card may then be taken by the consumer to his or her home and used to provide content to, for example, computers and various console devices, such as the Sony Playstation 3® the Microsoft X-box or X-box 360®, and the Nintendo Wii®, among other game consoles. Alternatively, the secure flash card 65 may be used in conjunction with a converter for providing content to devices which can not interface directly with the secure flash cared, such as a television or other playback device lacking an appropriate connector to connect to the secure flash card. Similarly, the secure flash card 65 may also be used to provide content for a projector, iPod®, or playback systems, such as the system manufactured by ARCHOS, that have connectors that will allow the secure flash card to be connected to the playback device.

Additionally, use of the secure flash card 65 in accordance with the several embodiments of the present invention to provide content to a user's playback device is not limited to devices commonly thought of as content display devices, such as mentioned previously. For example, the secure flash card 65 may also be configured to interface, for example, with cell phones, e-books, and digital picture frames, among other devices, to allow playback of the digital content stored on the secure flash card 65 on those devices.

The system described in the various embodiments above operates as follows to provide digital content to a consumer. Media content in the form of either audio or visual media or other media types that may become available the future, will be acquired by the provider of the system of the present invention and would be appropriately compressed, encrypted, and watermarked, with appropriate digital rights management information added, and stored on content servers 25 of content delivery portion 5. The media would then be distributed through server 30 on a store-and-forward basis using a variety of existing secure electronic content distribution networks to kiosks 60 that are prominently placed in high-volume, high traffic locations such as, for example, grocery stores, gas stations, and coffee shops.

The form factor, or footprint, of the kiosk can take a variety of shapes and sizes. Kiosks will typically have a local storage component, such as a database or local server that is contained in a secure service area inaccessible to retail customers. Customers will access the processor of the kiosk using, for example, a touch screen interface to search for and identify digital content that the customer wished to buy or lease. Once the customer selects the digital content they wish to buy or lease, the customer places a secure flash card into a flash card connector and the digital content, along with any other information, such as may be required to manage or monitor the transaction, along with any digital rights management conditions or software required, is downloaded into the memory of the secure flash card. The secure flash card may be purchased by the customer from the kiosk. Alternatively, the customer obtains the secure flash card from another source, even a different kiosk, and uses that flash card to store the downloaded digital content. As will be discussed in more detail below, the management portion 10 of the system of the present invention is capable of identifying the flash card and tracking its use so as to perform various back office functions, including inventory management, accounting, billing and other pertinent functions required for manage and monitor retail transactions with a customer.

In some embodiments, kiosks 60 may include capabilities for allowing the consumer to use coin or other forms of cash to pay for content delivery. However, given the ready availability of ATM credit cards and other forms of card-based cash or credit equivalents, it is anticipated that in most cases, kiosks will only accept a credit or ATM debit card, thus eliminating the need to store cash or to service the kiosks to provide additional cash as cash is used up by consumers. This provides the advantage of not only eliminating costly cash replenishment, but also provides additional security and eliminates the temptation for theft from the kiosks. As the secure flash card is inherently secure, multiple credit numbers, debit numbers, PINs, biometric factors or unique codes can be stored on the secure flash card as well, eliminating the need for sue of separate payment systems.

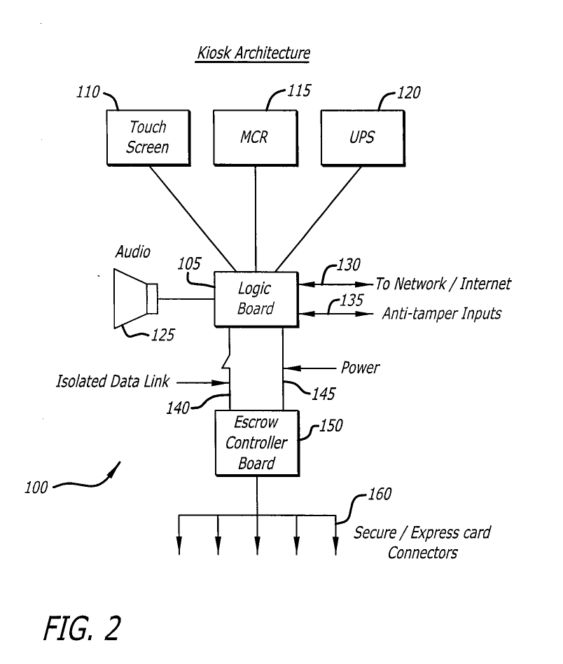

Referring now to FIG. 2, a block diagram illustrates the systems and sub-systems of one embodiment of a kiosk in accordance with the principles of the present invention. Typically, a kiosk will included, as stated previously, an interface to allow a customer to access a listing of the digital content available from the kiosk, and to select from the list of available content one or more items to be purchased or leased. For example, as shown in FIG. 2, the kiosk includes a touch screen 110 for displaying the list of content and allowing the customer to select the content by touching the screen. Such touch screens are commonly used, and thus will not be described in detail here.

The kiosk also includes a memory storage device 115, which may take whatever form is most appropriate for the size and expected usage of the kiosk. For example, the memory storage device 115 may be a very large capacity hard drive or several hard drives as needed to provide the required amount of data storage. Alternatively, the memory storage device may be provided by other means, such as reusable formats such as high capacity DVDs or solid state memory. The kiosk will also typically included an uninterruptible power supply 120 to ensure that, in the event of a power failure, no data is lost from the memory and perhaps even to provide for operation of the kiosk in the event of a power failure.

The circuitry of the kiosk 100 also includes a logic board 105 that includes a processor and typically will include a working memory of some kind, such as RAM memory. Various communication lines will connect the logic board 105 to the other subsystems of the kiosk as shown in FIG. 2, including, for example, an audio output device 125, such as a loud speaker.

Logic board 105 is connected to the content delivery portion 5 of the system illustrated in FIG. 1A by communication line 130. This communication line may take the form of an Internet, Ethernet or other high bandwidth connection, and may be either wired or wireless. The high bandwidth connection may be provided by either a dedicated private connection or a public connection using appropriate data security hardware and software. Additionally, in some embodiments, communication line 135 may provide access to additional anti-tampering inputs, including mechanical tamper switches, shock sensors and environmental sensors.

Logic board 105 is connected through an isolated data link 140 to an escrow controller board 150. Escrow controller board 150 provides a local cache to receive digital content from the memory 115, or other source, such as the Internet, to secure flash card connectors 160 configured to connect to and provide communications between a secure flash card, such as has been previously described, and the circuitry of the kiosk. Isolated data link 140 provides security from attack by a hacker trying to access the logic board of the kiosk through the secure flash card connectors 160. As shown in FIG. 2, the escrow controller board 150 may be powered the power supply of the logic board by power line 145. Alternatively, the escrow controller board 150 may be powered by a separate power supply, or a spur from power supply 120.

Several advantages are provided using the logic board and escrow controller boards as described with reference to FIG. 2. For example, the escrow controller board 150 of the kiosk is isolated from the logic board of the kiosk and thus also isolates the secure flash connectors 160 from the logic board 105. This helps secure the kiosk from attacks using the secure flash card connectors 160 to attempt to penetrate the system. In other words, use of the escrow controller board 150 provides a level of security to the operation of the kiosk in such a manner that the remainder of the system, including the content databases, servers, inventory management servers, and back office/management servers are isolated from interference by someone who may wish to penetrate the system and either steal information from those servers or takeover the system to use for their own purposes.

This escrow system may also be implemented by logical means, rather than electrical means, by use of multiple virtual machine images running under a controller on the same processor hardware and software. In this way, the process running the kiosk implementation has no direct access to the secure flash connectors 160, and success by an attacker in compromising the process transferring the content to the flash memory cards does not result in a breach of the main kiosk functionality or provide access to transaction information.

Various methods of communicating digital content from the content servers 25 of the content delivery portion 5 of the system illustrated in FIG. lA are contemplated. As stated previously, in order to provide a wide breadth of selection of digital content to a prospective customer, a large number of titles must be made available from the kiosk 60. Thus, the data stored in the memory 115 of the kiosk must be managed as new titles are added and old titles are deleted. Server 30 (FIG. 1A), in cooperation with inventory management servers 40, and the various systems of management portion 10, will communicate with the various kiosks of the system to update and manage the inventory of the system. In one embodiment, for example, new digital content may be communicated during off-hours to take advantage of lower transmission rates and readily available bandwidth. In other embodiments, where feasible, dedicated high speed connections may be used to ensure that high speed downloading of digital content can be accomplished. Alternatively, a variety of methods may be used under the control of the content delivery system 5 to ensure that a wide range of titles are available at the kiosk for immediate download to a customer.

In alternative embodiments, the kiosk may provide the customer with the capability of requesting a specific title that is not immediately available from the kiosk. In this case, the logic board of the kiosk can communicate to the customer that the content can be made available, with an estimated wait time so that the customer can choose to wait, or come back at a future time to download the content. In still another embodiment, the content delivery portion 5 may take note of various requests for content not immediately available and may, in cooperation with the various inventory management servers and management portion 10, request that the content be obtained and downloaded to the kiosk during the next scheduled update of the digital content stored in the memory of the kiosk. In still other embodiments, this feature may be implemented with other user interfaces, including through a web site, telephonically, email or SMS (secure message system) text requests. One embodiment of the system could also allow the requested content to be downloaded at multiple points simultaneously, providing for increased convenience to a consumer by increasing the locations the consumer can receive the download. In other words, such an embodiment would allow the consumer to place an order at one location and receive the downloaded content at another location. For example, a consumer running errands to pick up the download at any kiosk within a reasonable geographical area, rather than requiring the consumer to return to a particular kiosk.

One important aspect of the present invention includes the software systems incorporated into not only the servers of the content delivery portion 5 and management portion 10, but also into the logic board 105 and escrow controller board 150 of the kiosks. For example, it is possible to incorporate various digital right management (DRM) processes, such as, for example and not limited to, the various Content Protection for Recordable Media specifications (CPRM) available by license from 4C Entity, LLC, in the system to protect the downloaded content from inappropriate copying or alteration by users of the system. For example, in one DRM system, both content data and content key information, where the content key information is used to protect the contact data from unauthorized copying or alteration, can be downloaded simultaneously onto the memory storage device. Using such a system, a user would get encrypted data content. When the user desires to play the encrypted data content back, the user would need to have the right to access the encrypted content, access which would be granted by providing the key once the purchase or rental transaction had taken place. Of course, there are many digital rights management systems currently available for use, and the various embodiments of the systems of the present invention are capable of being adapted or upgraded to allow their use. This ability to upgrade the systems is also useful in that the systems may be upgraded to use future digital rights management systems developed in the future. Moreover, since content owners may select differing digital rights management systems for their content, the system will also be able to simultaneously support different digital rights management systems so that the wider choice of content can be made available to a consumer for purchase or rent.

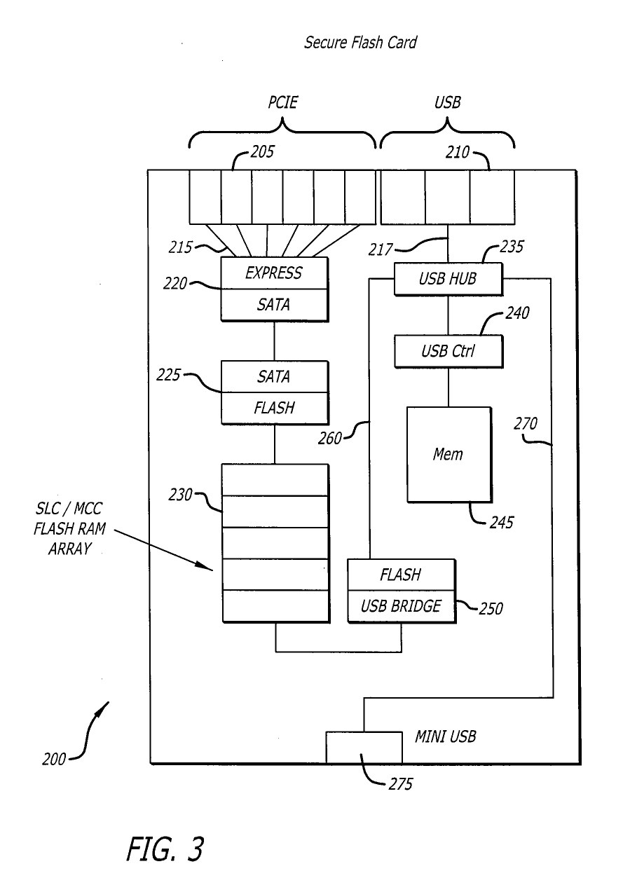

Referring now to FIG. 3, one embodiment of a secure flashcard 200 in accordance with principles of the present invention is described. In the illustrated exemplary embodiment, the form factor of the secure flashcard 200 is that of an ExpressCard device. Such a form factor is readily available, and has been used for several years. The secure flashcard 200 of this embodiment of the present invention, however, includes additional circuitry to that commonly included in known ExpressCards.

For example, secure flashcard 200 includes both Peripheral Component Interconnect Express (PCIE) connector 205 and a Universal Serial Bus (USB) connector 210. The PCIE connector currently provides for data communication at speeds as high as 16 gigabits per second. This is the communication path that is used by the secure flashcard 200 to receive digital content from a kiosk at a rate that allows for a vast amount of content to be downloaded in a relatively short period of time that is convenient for the purchases or lessee the content. USB connector 210 can also be used to input information into the secure flashcard 200, as will be discussed in more detail below.

PCIE connector 205 and USB connector 210 are located upon one edge of the secure flashcard 200. The form factor of the secure flashcard 200, and the PCIE connector 205 and USB connector 210 are configured to be received into the secure card connectors 160 (FIG. 2) of a kiosk, computer, or can also be received into suitable connectors of various playback devices.

The architecture of the secure flashcard 200 being described with reference to FIG. 3, differs from other prior art flashcards because it is believed to the first flash card form factor that simultaneously uses both PCIE and USB buses to carry data into and through the card. Having both PCIE and USB buses allows the card to not only interface with the kiosk, but also provides for a common interface to typical input ports for various playback equipment. The novel architecture of the secure flashcard 200 also provides a system that is capable of transporting content in the reverse direction. For example, the secure flashcard 200 may be used to provide portable data storage that is capable of interfacing with a suitable programmed system to provide for data access, transfer and playback at speeds not attainable by any other presently available storage system having the small footprint provided by the ExpressCard form factor. In this manner, very large transfers of information between end users can be accomplished with the convenience of exceptionally fast transfers to and from one removable media.

Communication channels 215 connect the PCIE input 205 with converter 220 which converts the signals from the PCIE connector 205 from an express data format to a SATA, or Serial ATA, format. The signals are then communicated to converter 225 where the SATA signals are transformed to flash memory format, and then communicated into a flash memory RAM array 230 for storage. While this conversion process is shown using discrete components, those skilled in the art will understand that all of the described process may be carried out by a single suitable designed and programmed integrated circuit. This concept of integration also applies to other discrete circuitry or components described below, to the extent that isolation of various components is not compelled by other considerations.

USB input 210 is connected via communication channels 217 to a USB hub which is in turn connected to a USB controller 250. USB controller 240 has access to a secure memory partition 245, which can be of various sizes depending upon the design requirements of the particular application. Communication channel 260 connects the USB hub 235 with the flash RAM array 230 by way flash/USB bridge converter 250. In this manner, USB controller 240 is capable of controlling, using appropriate programming that may be stored in memory 245 or embedded in the processor of the USB controller 240, the flow of information through the device, including the flow of information from the PCIE input and/or USB input, through communication channel 270 to output 275. Output 275 may take various forms, such as, for example only and not limited to, a mini USB port.

Because the novel electronic architecture of secure flashcard 200 includes both PCIE and USB connectors, utilization of USB controller 240 allows for data flow within flashcard 200 system at both PCIE and USB speeds. Furthermore, the system can be used to encrypt the customers own content in an exceptionally secure manner because the encryption key can be tied to the secure flashcard 200 itself. The encryption key is tied to the card, for example, by incorporating the appropriate data within memory 245, that is then accessed by appropriately programmed USB controller 240. In this manner, data security can be provided through dual factor authentication without the need for cumbersome pre-registration techniques required by other storage devices. Moreover, because the system uses the PCIE bus, the system is capable of supporting bitrates that allow not only standard definition, but also high-definition and theatrical definition playback of stored content.

The secure flashcard 200, is not only reusable, but can also be randomly, quickly and partially erased, unlike a CD-RW or DVD-RW disk. Additionally, the inclusion of the USB controller 240 and associated software to control the flow of information through the circuitry, particularly upon playback, allows for book marking, that is, tracking where a user left off in their viewing of the data stored within flash memory array 230, even though the user may have changed players or platforms for the playback of the information. Moreover, appropriately programmed USB controller 240 provides for time stamping the exact playout order and duration of the use of the media stored in flash RAM array 240 for auditing and metadata purposes. Such data may be accessed by the management portion 10 (FIG. 1A) of the system through the connection with the kiosk, for example, the next time a customer inserts the secure flashcard into a kiosk to either purchase or lease additional content, or to otherwise check on the status or content of the contents of the flashcard. Alternatively, the hardware or software of a customer's playback device may store data such as “breadcrumbs” in either the main memory array 230 or the secure memory 245 of secure flash card to facilitate these functions.

Furthermore, use of the memory 245 of the secure flash card 200 to store customer specific information which can be downloaded into the memory along with the digital content download when the express card is interfaced with the express card connector 160 (FIG. 2) of a kiosk provides for identifying the owner of the storage device. Such identification can facilitate return or replacement of the storage device if the storage device is lost stolen or degraded.

Another advantage of using the architecture of the present system is that there are no inherent limitations or arbitrary file or codec requirements. As such, technological advances such as increases in capacity or memory 230 and additional DRM conditions or other data flow standards may be updated to the memory 245 of the secure flashcard 200 as necessary to improve the performance of the device.

Yet another advantage of the various embodiments of the present invention is that the USB controller 240 may also be programmed to allow a user who is renting or leasing digital content to download multiple programs of digital content and yet pay only for the titles of the content that are actually played back. Similarly, when the digital content is being purchased by a user, the user may download multiple titles, but actual purchase of the content can be deferred to a future purchase transaction. Again, because of the novel aspects of the secure flashcard 200, various methods such as those described above can be used concurrently with one another at the same time on the same storage device. Moreover, since the secure flashcard 200 utilizes a standardized interconnection method such as the USB standard, additional functions can be added to allow for use with a large base of existing consumer electronic hardware. For example, most computers, digital video recorders and other playback devices typically use USB inputs, and have the ability to decode content provided to those devices through the USB connection.

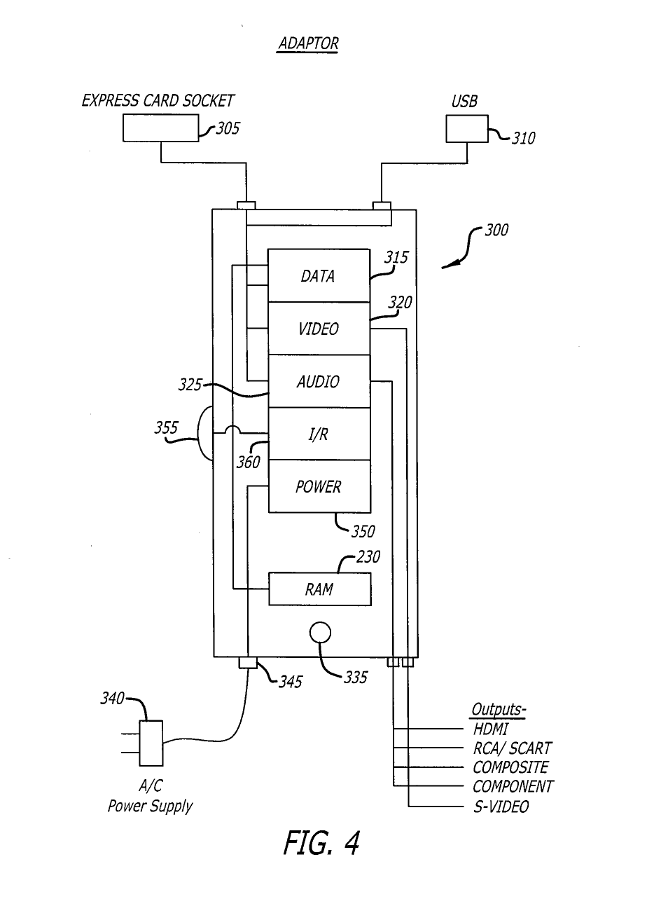

Referring now to FIG. 4, there is illustrated an exemplary embodiment of an adapter 300 that can be used to connect the secure flashcard 200 of FIG. 3 to a playback device that could not otherwise be connected to the flashcard, either because of hardware or signal incompatibility. The adaptor is configured to convert the signals from the secure flashcard representing the data stored within the flash RAM array of the secure flashcard 200 and provide them to an output that can then be connected to a variety of playback devices. In one embodiment, the adapter is constructed as part of connector cord, and thus is small and unobtrusive.

Adapter 300 includes a PCIE connector 305 and a USB connector 310. As described with reference to the secure flashcard 200 of FIG. 3, such dual connectively allows for increased usefulness of the adapter.

Inputs from PCIE connector 305 and USB connector 310 are electrically connected to data converter 315, video converter 320 and audio converter 325. These converters accept signals from the express card and USB inputs and provide them to outputs such as, for example, HDMI, RCA/SCART composite, component, and S-video outputs, and others. The converters 315, 320 and 325 include processors which may be programmed using software commands either stored within a memory accessible by the processors or which is imbedded within the architecture of the processors. This allows the processors to be updated as needed as standards change or as new functionality is required because of advances in playback technology. Those skilled in the art will understand that such discrete converters as illustrated in FIG. 4 may be replaced by integrated circuitry and firmware instructions.

Examples of processors, which may also include integrated memory and embedded operating software, that may be used to perform the conversion are, for example, and not limited to, the Broadcom BCM7405 and BCM7411, the Nexperia STB225, the BridgeCo DM850e, the Freescale MCIMX31C, the Sigma Designs 8635, 8655, EM8622L and EM8624L, the STMicroelectronics STB7100 and the Conexant CX2418X.

Adapter 300 may be powered using an AC power supply 340 that is capable of being plugged into a wall socket to access 100 to 240 volt alternating current. Power supply 340 will typically reduce and convert the alternating current to an appropriate voltage of direct current. The power cord may be hard wired, or may terminate in a plug that can be inserted into an input 345 which is in communication with power section 350 of the converter to power the electrical circuitry of the adapter.

Adapter 300 may also include an infrared receiver 355 that is operably connected to either a separate infrared processor 360, or a portion of an integrated circuit that is designed to allow for input of signals from infrared receiver 355 to control the operation of the processor. Infrared receiver 355 thus allows for easy updating of the programming and contents of RAM memory 230 which can be used to update the functionality of the adapter or to add or remove various digital rights management functionality.

The adapter may also include a status indicator 335 to indicate using either changes of color or changes in flash rate. The status of the operation of the adapter. For example, indicator 335 may glow one color when receiving data through an express card socket or may glow another color when receiving data through the USB connector 310. It may also indicate the status of the memory 230 during an updating procedure, for example, using one color or sequence of flashes to indicate that the memory is ready to receive information transmitted through the IR port 355, and use another color or sequence of flashes to indicate that the data has been received and stored without error in memory 230 of the adapter.

In another embodiment of the present invention, RFID technology may be incorporated throughout the system, or in just a portion of the system, such as the kiosk or the secure flashcard. Such RFID technology would, for example, provide for multifactor authentication for security purposes or for traditional tracking and inventory management purposes.

While several particular forms of the invention have been illustrated and described, it will be apparent that various modifications can be made without departing from the spirit and scope of the invention.

I claim:

1. A method for providing digital content to a user, comprising:
providing digital content in a searchable database located on a server in communication with a user-accessible point of delivery;
providing software programs for configuring the operation of a processor and associate memory to facilitate provision of user-selected digital content to the user, including programs for allowing a user to search the searchable database of digital content, programs for controlling the retrieval of digital content from the searchable database, programs for managing the searching and selecting process, programs for tracking the searching, selecting and delivery processes, programs for monitoring inventory, including stocking and re-stocking, programs for providing accounting functions associated with the delivery of the selected digital content, including functions associated with buying and/or leasing the selected digital content, including operations related to communicating with and charging or debiting a user's bank account, programs for providing digital rights management of the provided digital content, and programs for providing reporting of inventory usage, revenue generation and expenses and any other reports necessary to track usage, and in the case of a lease of the digital content, track the term of the lease, charge additional amounts to a user's account if the digital content is not returned at the end of the lease, or to incorporate within the download of digital content to a user supplementary content that would result in the deletion of the downloaded digital content at the end of the term of a lease;
wherein the user-accessible delivery point includes facilities for local storage of digital content, interface means for allowing the user to interface with the system for searching for and selecting digital content to be delivered, and for providing a means for the user to purchase or lease the digital content, including means for charging the user's credit or debit account for an amount associated with the lease or purchase of the digital content; and
a communication port configured to allow for rapid downloading of digital content to a portable memory device for use by the use with user accessible digital content playback devices.

2. A portable memory storage device, comprising:
a high speed data port, such as a PCIE port;
a USB port;
electronic circuitry, including conversion means in operable communication with the PCIE port to convert data flow from the PCIE port to a form usable by a flash memory,
a USB hub, controller and associated memory in operable communication with the USB port,
an output port, and
communication means providing for data flow between the PCIE input port, USB input port the conversion means, flash memory, USB hub and controller and the output port;
wherein the controller controls the flow of data through the electronic circuitry.

3. The portable memory storage device of claim 2, wherein the PCIE port is configured to receive digital content from a digital content delivery system, as described in claim 1.

4. The portable memory storage device of claim 3, wherein the received digital content is stored in the flash memory.

5. The portable memory storage device of claim 4, wherein the stored output port is releasably connected to playback or storage device, and the controller provides for retrieval of digital content stored in the flash memory which is then communicated under user control through the output port to the playback or storage device.

6. The portable memory storage device of claim 2, wherein the controller is programmed to provide the capability for communicating digital content stored in the flash memory to the output in accordance with digital rights management conditions or provider usage conditions stored in the memory or flash memory.

7. A customer point of content delivery system for providing digital content to a customer, comprising:
a user-interface, including input and output capabilities, an escrow controller;
an output configured to interface with and communicate with a portable digital content storage device;
a processor configured to operate in accordance with software to control the display of content on the user interface and to accept user input, the processor responsive to the user input to control the display of information to the user and to control the escrow controller to provide for downloading user selected digital content through the output.

8. The delivery system of claim 7, wherein the controller is in communication with a server, the server being part of a digital content supply system for supplying digital content to the delivery system for delivery to the user through the output, the server also being part of management control system for managing, monitoring and controlling the delivery of digital content to the user and for managing, monitoring and controlling purchase or lease processes associated with delivery of the digital content to the user.

9. An adaptor for receiving digital content from a portable content storage device and converting the signals representing the digital content to a form usable by a playback or display device, comprising:
a connector for operably communicating with a portable content storage device;
conversion means for converting digital content to a form usable by a playback or display device;
memory for storing programming used to control conversion means and for controlling the flow of date through the adaptor;
input means for accepting user input;
output means for operably communicating output of the conversion means to a playback or display device in operable communication with the output means; and
a processor for controlling the conversion means and the flow of digital content through the adaptor in accordance with user input and also in accordance with programming stored in the memory.

10. The adaptor of claim 9, wherein the conversion means includes means for converting data, video information and audio information.

11. The adaptor of claim 10, further comprising a status indicator for indicating the status of operation of the adaptor to a user.
